(19) United States
(12) Patent Application Publication
(10) Pub. No.: US 2008/0080477 A1
(43) Pub. Date: Apr. 3, 2008

(54) SYSTEM AND METHOD FOR CONNECTION FUNCTIONALITY

(75) Inventors: Thomas Block, Wuppertal (DE); Patrick Clauberg, Dortmund (DE)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/537,771

(22) Filed: Oct. 2, 2006

(51) Int. Cl. H04L 12/28

(52) U.S. Cl. 370/351

(57) ABSTRACT

Systems and methods applicable, for example, in connection functionality. A device might, for instance, provide connection to one or more services via one or more devices. The device might, for example, detect a device offering one or more of those services. The device providing connection might, for instance, consider one or more priorities, connection disruption indications, and/or connection maintenance indications. The device providing connection might, for example, stop providing connection via one or more of the devices via which connection was being provided, and/or might start providing connection via the detected device.

### FIELD OF INVENTION

This invention relates to systems and methods for connection functionality.

### BACKGROUND INFORMATION

In recent times, there has been an increase in users employing their devices in providing connection to services.

For instance, many users have come to prefer employing their devices in providing connection to various services over other ways of coming to possess various capabilities.

Accordingly, there may be interest in technologies that facilitate such use of devices.

### SUMMARY OF THE INVENTION

According to embodiments of the present invention, there are provided systems and methods applicable, for example, in connection functionality.

A device might, in various embodiments, provide connection to one or more services via one or more devices. In various embodiments the device might detect a device offering one or more of those services.

The device providing connection might, in various embodiments, consider one or more priorities, connection disruption indications, and/or connection maintenance indications. In various embodiments, the device providing connection might stop providing connection via one or more of the devices via which connection was being provided, and/or might start providing connection via the detected device.

### BRIEF DESCRIPTION OF THE DRAWINGS

FIG. 1 shows exemplary steps involved in setup operations according to various embodiments of the present invention.

FIG. 2 shows exemplary steps involved in use operations according to various embodiments of the present invention.

FIG. 3 shows further exemplary steps involved in use operations according to various embodiments of the present invention.

FIG. 4 shows still further exemplary steps involved in use operations according to various embodiments of the present invention.

FIG. 5 shows an exemplary computer.

FIG. 6 shows a further exemplary computer.

### DETAILED DESCRIPTION OF THE INVENTION

### General Operation

According to embodiments of the present invention, there are provided systems and methods applicable, for example, in connection functionality.

A device might, in various embodiments, provide connection to one or more services via one or more devices offering those services.

In various embodiments the device might detect (e.g., via device discovery and/or service discovery) another device offering one or more of those services.

The device providing connection might, in various embodiments, consider one or more priorities, connection disruption indications, and/or connection maintenance indications associated with the offering, by the detected device, of one or more of the services to which connection is being provided, and/or might consider one or more priorities, connection disruption indications, and/or connection maintenance indications associated with the offering, by one or more of the devices via which connection is already being provided, of one or more of the services to which connection is being provided.

In various embodiments the device providing connection might stop providing connection, via one or more of the devices via which connection is being provided, to one or more of the services to which connection was being provided, and/or might start providing connection, via the detected device, to one or more of those services.

Priorities, connection disruption indications, and/or connection maintenance indications might, in various embodiments, be provided. Such provision might, in various embodiments, be via a Graphical User Interface (GUI) and/or other interface, and/or be in conjunction with one or more devices coming to be trusted devices.

It is noted that, in various embodiments, devices discussed herein might, for instance, be proximity networking devices and/or other computers.

Various aspects of the present invention will now be discussed in greater detail.

### Setup Operations

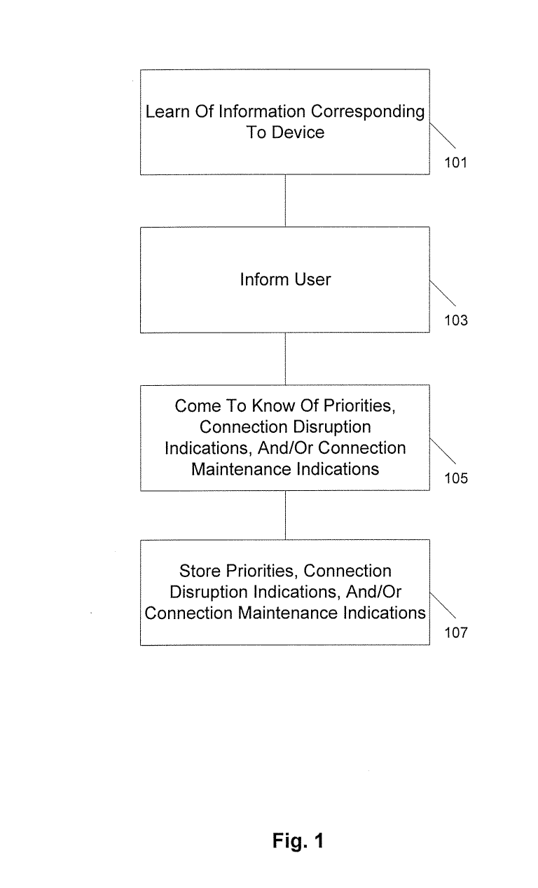

With respect to FIG. 1 it is noted that, according to various embodiments of the present invention, a device might learn of various information corresponding to another device (step 101). Such might, for example, occur via service discovery and/or device discovery. For instance, Domain Name System Service Discovery (DNS-SD) and/or Bluetooth device discovery might be employed. The devices might, for instance, be Bluetooth, WiFi, Radio Frequency Identification (RFID), Near Field Communication (NFC), and/or Infrared Data Association (IrDA) devices. It is noted that, in various embodiments, Bluetooth discussed herein might involve IEEE 802.15.1 and/or Ultra-Wideband (UWB). It is further noted that, in various embodiments, WiFi discussed herein might involve IEEE 802.11b IEEE 802.11g, and/or IEEE 802.11n.

The device that learns of such information might, in various embodiments, come to do so at various points in time. For example, the device might learn of such information with initially coming to know of the other device (e.g., with initial discovery), and/or with establishing the other device as a trusted device (e.g., with pairing with the other device). It is noted that, in various embodiments, a trusted device might be able to be automatically authenticated.

Learned information might, for instance, include one or more identifiers corresponding to the other device, and/or information regarding one or more services offered by the other device. Such identifiers might, for example, include Bluetooth addresses, Media Access Control (MAC) addresses, and/or network addresses. Such services might, for instance, include services corresponding to audio input, audio output, image capture (e.g., camera capture and/or scanning), image output (e.g., display and/or printing), data transfer, device control (e.g., relating to human interface and/or to automated control), and/or storage. Such services corresponding to audio input and/or audio output might, for example, include services corresponding to hands-free operation (e.g., for telephony), microphone input (e.g., for sound recording), and/or headphone output (e.g., for output of music and/or high quality audio). It is noted that, in various embodiments, such services might be offered in accordance with one or more profiles (e.g., one or more Bluetooth profiles).

The device that learned of the information might, for instance, inform its user of such information (step 103). Such might, for example, occur via one or more Graphical User Interfaces (GUIs) and/or other interfaces. The device might, for instance, inform its user of various services offered by, and/or or more identifiers associated with, the other device, and/or one or more further devices.

The device that learned of the information might, for example, come to know of one or more priorities, connection disruption indications, and/or connection maintenance indications for one or more services as offered by the other device, and/or one or more further devices (step 105).

Such priorities might, for instance, be numerical. It is noted that, in various embodiments, a priority having a higher numerical value might be considered to exceed and/or have a higher priority than a priority having a lower numerical value. It is further noted that, in various embodiments, a priority having a lower numerical value might be considered to exceed and/or have a higher priority than a priority having a higher numerical value.

Association of a connection disruption indication with the offering of a service might, for instance, serve to express that connection to that service in accordance with that offering should, under various circumstances, be provided in preference to provision of connection to that service in accordance with one or more other offerings of that service. For example, the offering of a hands-free service by a device in association with a connection disruption indication might serve to indicate that, under various circumstances, provision of connection to the hands-free service via one or more other devices should be stopped, and provision of connection to the hands-free service via the device should be started.

Association of a connection maintenance indication with the offering of a service might, for instance, serve to express that connection to that service in accordance with that offering should, under various circumstances, be maintained in preference to provision of connection to that service in accordance with one or more other offerings of that service. For example, the offering of a hands-free service by a device in association with a connection maintenance indication might serve to indicate that, under various circumstances, provision of connection to the hands free service via that device should be maintained even if the service is being offered by one or more other devices.

The device that learned of the information might come to know of one or more priorities, connection disruption indications, and/or connection maintenance indications for one or more services in a number of ways. For example, the device that learned of the information might receive specification of such priorities, connection disruption indications, and/or connection maintenance indications from its user (e.g., via a GUI and/or other interface). As another example, the device might determine such priorities, connection disruption indications, and/or connection maintenance indications.

The user might, for instance, be presented (e.g., via a GUI and/or other interface) with indication one or more services offered by one or more devices, and/or might be able to indicate with respect to one or more such service offerings one or more priorities, connection disruption indications, and/or connection maintenance indications.

For instance, the user might receive (e.g., via a GUI and/or other interface) indication that a particular device (e.g., one that has just been initially discovered and/or established as a trusted device) offers a hands-free service and a camera capture service, and/or might be able to provide indication (e.g., via a GUI and/or other interface) of priorities, connection disruption indications, and/or connection maintenance indications corresponding to the offering by that device of the hands-free service and/or the offering by that device of the camera capture service.

As yet another example, the device might receive such priorities, connection disruption indications, and/or connection maintenance indications from one or more accessible stores (e.g., remote and/or local stores) and/or devices (e.g., remote servers). Such receipt might, for instance, involve the use of Bluetooth (e.g., IEEE 802.15.1 and/or UWB Bluetooth), IEEE 802.11b. IEEE 802.11g, IEEE 802.11n, IEEE 802.16e, Local Area Network (LAN), Wide Area Network (WAN) (e.g., the Internet), Web-based Distributed Authoring and Versioning (WebDAV), File Transfer Protocol (FTP), Apple Filing Protocol (AFP), Server Message Block (SMB), Really Simple Syndication (RSS), General Packet Radio Service (GPRS), Universal Mobile Telecommunications Service (UMTS), Global System for Mobile Communications (GSM), Simple Object Access Protocol (SOAP), Java Messaging Service (JMS), Remote Method Invocation (RMI), Remote Procedure Call (RPC), sockets, and/or pipes.

Priorities, connection disruption indications, and/or connection maintenance indications that the device came to know of might, for instance, be stored by the device (e.g., as a list of devices) (step 107). Such storage might, for example be at one or more remote and/or local stores. Such a remote store might, for instance, be accessed in a manner employing one or more of the communication modalities discussed above.

Storage might, for example, be in conjunction with identifiers corresponding to devices. For instance, stored with respect to a particular device might be one or more identifiers corresponding to that device, and/or one or more priorities, connection disruption indications, and/or connection maintenance indications corresponding to services offered by that device.

Priorities, connection disruption indications, and/or connection maintenance indications determined by the device, and/or received by the device from one or more stores and/or devices, might, in various embodiments, be determined in a manner taking into account one or more factors. For instance, usage patterns of one or more users (e.g., service usage patterns) might be taken into account.

It is noted that, in various embodiments, priorities, connection disruption indications, and/or connection maintenance indications might correspond to a device. For instance, a user might (e.g., via a GUI and/or other interface) specify a priority, connection disruption indication, and/or connection maintenance indication corresponding to a device. It is noted that, in various embodiments, a priority, connection disruption indication, and/or connection maintenance indication corresponding to a device might serve to apply to each of one or more services offered by that device.

### Use Operations

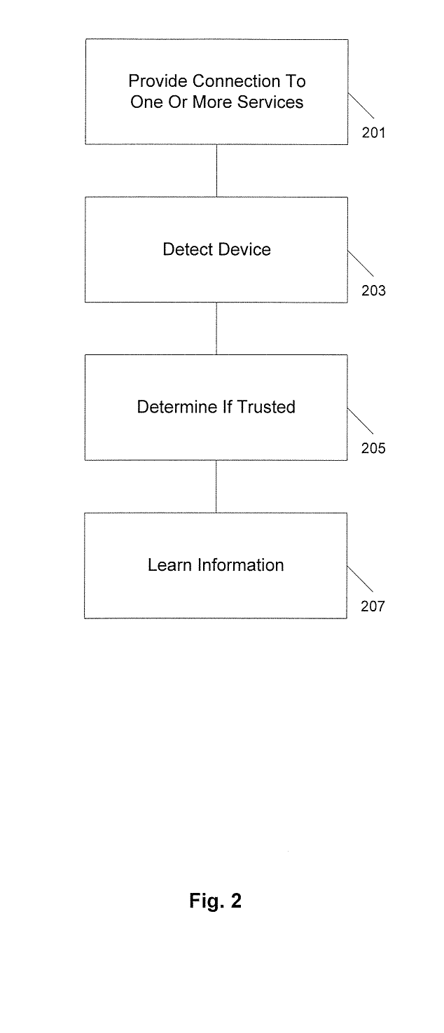

With respect to FIG. 2 it is noted that the device (e.g., a Bluetooth and/or WiFi device) might, in various embodiments, provide connection to one or more services via one or more devices (e.g., one or more Bluetooth and/or WiFi devices) offering those services (step 201). Such provision of connection might, for instance, involve one or more of the communication modalities discussed above (e.g., Bluetooth might be employed).

For example, the device might provide connection to a hands-free service via a device offering the service such that the device offering the service could be employed as a microphone and/or headset for hands-free operation of the device that is providing connection.

The device that is providing connection might, for instance, detect another device (step 203). Such a detected device might, for instance, be one offering services to which connection was already being provided.

Such detection might, for instance, be via device discovery, via service discovery, and/or via connection creation (e.g., a user might indicate that a connection should be created). The device that is providing connection might, in various embodiments, determine if the detected device was a trusted device (e.g., one with which pairing had been performed) (step 205).

The device that is providing connection might, for instance, learn of various information corresponding to the detected device (step 207). For example, the device that is providing connection might learn of one or more identifiers (e.g., one or more Bluetooth addresses) of and/or one or more services being offered by the detected device. Such functionality might, for instance, be performed in a manner analogous to that discussed above (e.g., DNS-SD and/or Bluetooth device discovery might be employed).

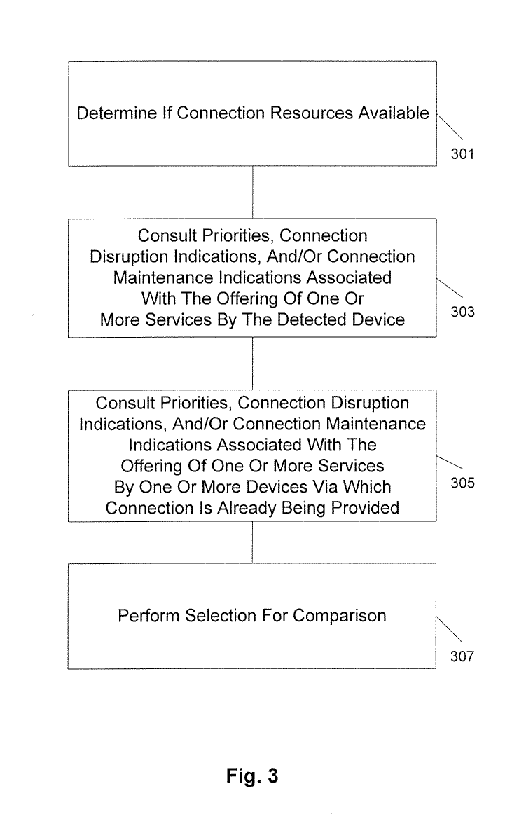

With respect to FIG. 3 it is noted that the device that is providing connection might, in various embodiments, determine if it had available connection resources corresponding to services being offered by the detected device (e.g., services, to which connection was already being provided via other devices, that were also being offered by the detected device (step 301).

For example, in the case where the device that is providing connection was providing connection to a hands-free service via one or more devices, and the detected device was offering the hands-free service, the device that was providing connection might determine if it had any available hands-free service connection resources.

The device that is providing connection might, for example, consult one or more priorities, connection disruption indications, and/or connection maintenance indications associated with the offering of one or more services by the detected device (step 303). Such consultation might, in various embodiments, involve the employment of one or more identifiers associated with the detected device.

As another example, the device that is providing connection might consult one or more priorities, connection disruption indications, and/or connection maintenance indications associated with the offering of one or more services by one or more devices via which connection was already being provided (step 305).

Consultation might, in various embodiments, be performed prior and/or subsequent to determination that connection resources were unavailable. It is noted that, in various embodiments, consultation might not be performed in the case where connection resources were found to be available. The services for which priorities, connection disruption indications, and/or connection maintenance indications are consulted might, for instance, be ones, to which connection is already being provided, that are also being offered by the detected device.

For example, in the case where the device that is providing connection is providing connection to a hands-free service via one or more devices, and the detected device is offering the hands-free service, the device that is providing connection might consult a priority, a connection disruption indication, and/or a connection maintenance indication associated with the offering of that service by the detected device, and/or one or more priorities, connection disruption indications, and/or connection maintenance indications associated with the offering of that service by one or more devices via which connection is already being provided.

The device that is providing connection might, in various embodiments, compare one or more of the consulted priorities, connection disruption indications, and/or connection maintenance indications associated with the offering of one or more services by the detected device with one or more of the consulted priorities, connection disruption indications, and/or connection maintenance indications associated with the offering of one or more services by one or more devices via which connection is already being provided.

In various embodiments, for each of one or more particular services, the consulted priority, connection disruption indication, and/or connection maintenance indication associated with the offering of that service by the detected device might be compared to one or more selected consulted priorities, connection disruption indications, and/or connection maintenance indication associated with the offering of that service by one or more devices via which connection is already being provided.

Selection (step 307) might be implemented in a number of ways. For example where connection is already being provided to that service via multiple devices, selection might correspond to the lowest of the priorities. For instance, in the case where connection was already being provided to the service via a first device in association with a lower priority, and via a second device in association with a higher priority, selection might correspond to the offering of the service via the first device.

It is noted that, in various embodiments, in the case where there was a tie for lowest priority, selection might correspond to a random selection from among the tied. For example, in the case where connection was already being provided to the service via a first device in association with a higher priority, via a second device in association with a lower priority, and via a third device in association with that same lower priority, selection might correspond to a random selection from among the offering by the second device and the third device.

It is further noted that, in various embodiments, in the case where there was a tie for lowest priority, but certain of the tied were associated with a connection maintenance indication but others were not, selection might be from among those tied that were not so associated. For example, in the case where only one of the tied was not so associated, that one might be selected. As another example, in the case where multiple ones of the tied were not so associated, random selection from among those ones might occur.

In various embodiments, all consulted priorities, connection disruption indications, and/or connection maintenance indications associated with the offering of the service by one or more devices, via which connection was already being provided, might be selected.

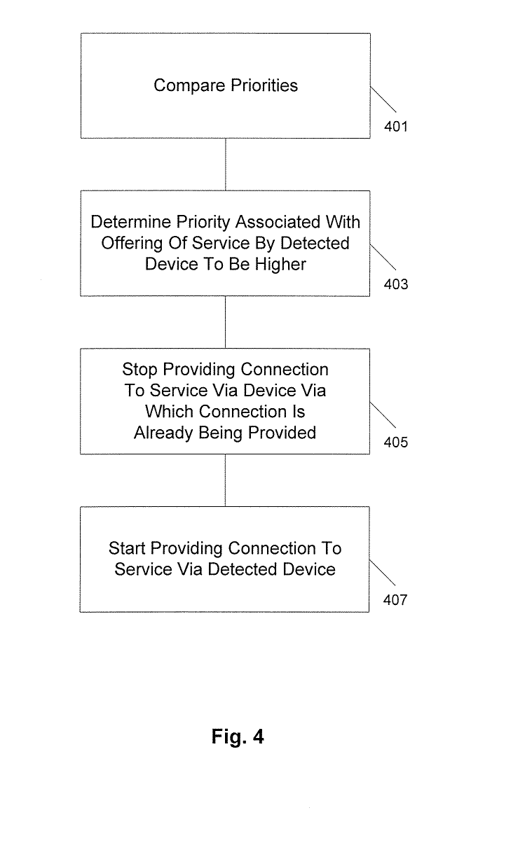

With respect to FIG. 4 it is noted that, in various embodiments, having selected for comparison the offering of the service by one of the devices via which connection is already being provided, the priority associated with the offering of the service by that device might be compared to the priority associated with the offering of the service by the detected device (step 401).

For example, in the case where it is determined that the priority associated with the offering of the service by the detected device was higher than the priority associated with the offering of the service by the device via which connection was already being provided (step 403), the device that is providing connection might stop providing connection to the service via the device via which connection was already being provided (step 405), and start providing connection to the service via the detected device (step 407).

It is noted that, in various embodiments, in the case where a connection maintenance indication is associated with the offering by the device via which connection is already being provided, the device that is providing connection might not alter the way in which it provides connection to the service (e.g., it might continue to provide connection via the device via which connection was already being provided).

In the case where the priority associated with the offering of the service by the detected device was not higher than the priority associated with the offering of the service by the device via which connection was already being provided, the device that is providing connection might, for example, not alter the way in which it provides connection to the service.

In various embodiments, in the case where the priority associated with the offering of the service by the detected device was within a specified range of the priority associated with the offering of the service by the device via which connection was already being provided, one or more operations might be performed. Such a range might, for instance, be specified by a user, by a system administrator, and/or by a manufacturer. The specified range might, for example, be such that the priority associated with the offering of the service by the detected device was the same as the priority associated with the offering of the service by the device via which connection was already being provided.

For example, under such circumstances, in the case where a connection disruption indication was associated with the offering of the service by the detected device, and/or a connection maintenance indication was not associated with the offering of the service by the device via which connection was already being provided, the device that is providing connection might stop providing connection to the service via the device via which connection was already being provided, and start providing connection to the service via the detected device. The device that is providing connection might, for instance, otherwise not alter the way in which it provides connection to the service.

As another example, under such circumstances, in the case where a connection disruption indication was associated with the offering of the service by the detected device, and a connection maintenance indication was associated with the offering of the service by the device via which connection was already being provided, one or more operations might be performed.

For example, the device that is providing connection might randomly choose to either not alter the way in which it provides connection to the service, or to stop providing connection to the service via the device via which connection was already being provided, and start providing connection to the service via the detected device.

As another example, in the case where the priority associated with the offering of the service by the detected proximity networking device was within the specified range of the priority associated with the offering of the service by the device via which connection was already being provided, but the priorities were not equal, where a higher priority was associated with the offering of the service by the detected device, the device that is providing connection might stop providing connection to the service via the device via which connection was already being provided, and start providing connection to the service via the detected device. The device that is providing connection might, for instance, otherwise not alter the way in which it provides connection to the service.

It is noted that, in various embodiments, in the case where connection is being provided to a service via multiple devices, and the device that is providing connection stops providing connection to the service via one of those devices and starts providing connection to the service via a detected device, the one of those devices for which connection provision is stopped might be the one of those devices associated with the lowest priority.

For example, in the case where connection to a hands-free service was being provided via multiple devices, a device offering the hands-free service was detected, provision of connection to the hands-free service via one of those devices was stopped, and provision of connection to the hands-free service via the detected device was started, the one of those devices for which connection provision was stopped might be the one that offered the hands-free service in association with a lower priority than the others of those devices.

It is noted that, in various embodiments, in the case where the offerings of the service by more than one of (e.g., all of) the devices via which connection was already being provided were selected for comparison, one or more operations analogous to those discussed above might be performed. Operations involving priorities, connection maintenance indications, connection disruption indications, and/or specified ranges might, for instance, be performed.

For example, having selected for comparison the offerings of the service by more than one of the devices via which connection was already being provided, for each of those devices the priority, connection maintenance indication, and/or connection disruption indication associated with the offering of the service might be compared to the priority, connection maintenance indication, and/or connection disruption indication associated with the offering of the service by the detected device.

In, for instance, the case where the priority associated with the offering of the service by the detected device was higher than none of the priorities, associated with the offering of the service, corresponding to the selected devices, the device that is providing connection might, for example, not alter the way in which it provides connection to the service.

In, for instance, the case where the priority associated with the offering of the service by the detected device was higher than only the priority associated with the offering of the service by one of the selected devices, the device that is providing connection might, for example, stop providing connection to the service via that selected device, and start providing connection to the service via the detected device.

In, for instance, the case where the priority associated with the offering of the service by the detected device was higher than the priorities associated with the offering of the service by more than one of the selected devices, the device that is providing connection might, for instance, perform one or more operations.

For example, in the case where the priority associated with the offering of the service by one of the more than one of the selected devices was exceeded to a greater extent than others of the priorities, the device that is providing connection might stop providing connection to the service via that selected device, and start providing connection to the service via the detected device.

In various embodiments, in the case where there was a tie with respect to greatest extent of exceeding, one of the corresponding selected devices might be randomly chosen to be the one via which the device that is providing connection stops providing connection to the service, with the device that is providing service starting provision of connection to the service via the detected device.

For example, in the case where the priority associated with the offering of the service by a first device via which connection was already being provided and the priority associated with the offering of the service by a second device via which connection was already being provided were equally exceeded by the priority associated with the offering of the service by the detected device, the device that is providing connection might stop providing connection to the service via a randomly-chosen one of the first device and the second device, and start providing connection via the detected device.

It is noted that, in various embodiments, when there is stoppage of providing connection to one or more services via a device, provision of connection to one or more other services via that device might be maintained. For example, provision of connection to a hands-free service via a device might be stopped, but provision of connection to an image capture service via that device might be maintained.

It is further noted that, in various embodiments, a user might receive indication (e.g., via a GUI and/or other interface provided by her device) corresponding to one or more of the operations discussed herein. For example, the user might receive indication regarding start of provision of connection to one or more services via one or more devices. As another example, the user might receive indication regarding stoppage of provision of connection to one or more services via one or more devices. As yet another example, the user might receive indication that no alteration was made regarding provision of connection to a service. In a further embodiment, the provisioned connection change might be shown to the user, and the user might, for instance, have the option to accept or reject the connection change. For example, when the found device and the device providing connection have the same priority, the user might be given the option to select or reject a connection change.

For instance, the user might receive indication that a device offering a service, to which connection was already being provided via one or more devices, was detected, but that a priority associated with the offering of that service by the detected device was lower than the priorities associated with the offering of that service by the devices via which connection was already being provided.

It is noted that, in various embodiments, a device might be an automobile and/or other vehicle.

### Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

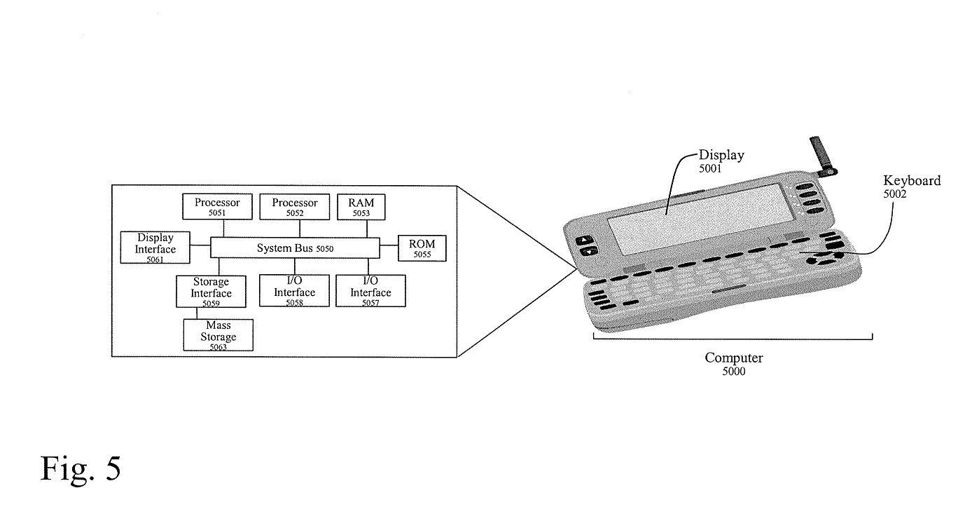

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 5 is an exemplary computer employable in various embodiments of the present invention. Exemplary computer 5000 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16×, IEEE 802.20, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 5063 may be a hard drive, optical drive, a memory chip, or the like. Processors 5051 and 5052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, an Intel Core, or an IBM, Toshiba, or Sony Cell processor. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

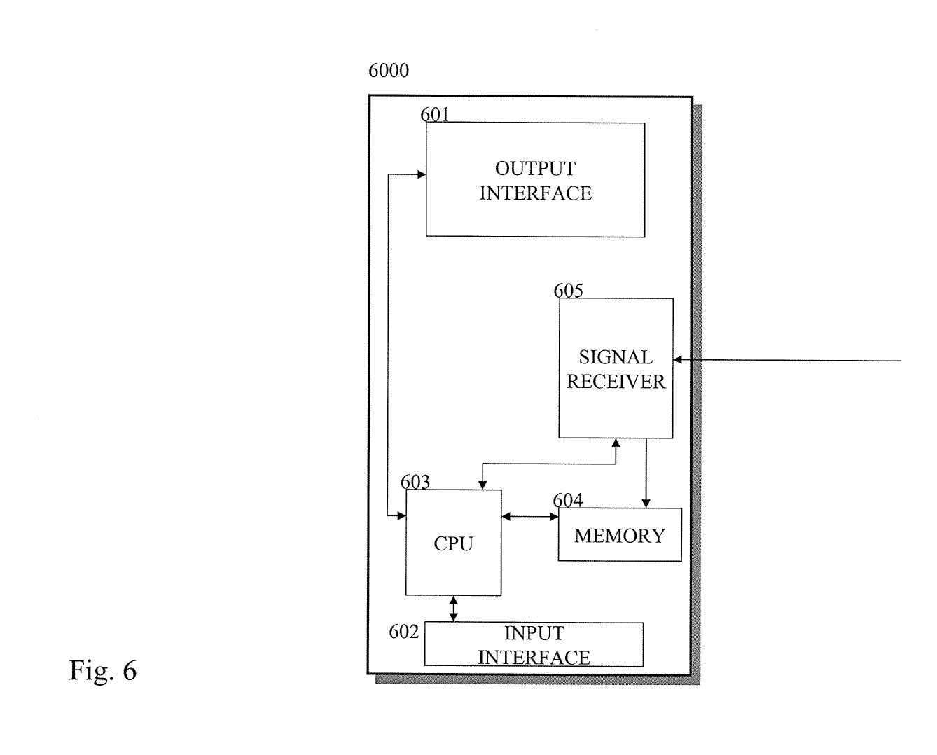

Shown in FIG. 6 is a block diagram of a terminal, an exemplary computer employable in various embodiments of the present invention. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between multi-carrier signal terminal part 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604, and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone which comprises the multi-carrier signal terminal part 605 for receiving multicast transmission streams. Therefore, the terminal 6000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

### RAMIFICATIONS AND SCOPE

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
providing connection to a service via a first proximity networking device offering the service;
detecting a second proximity networking device, wherein the second proximity networking device offers the service;
comparing a priority associated with the offering of the service by the first device with a priority associated with the offering of the service by the second device;
terminating the provision of connection to the service via the first device; and
providing connection to the service via the second device.

2. The method of claim 1, wherein the priority associated with the offering of the service by the second device exceeds the priority associated with the offering of the service by the first device.

3. The method of claim 1, wherein the priority associated with the offering of the service by the second device is within a predetermined range of the priority associated with the offering of the service by the first device, and wherein a connection disruption indication is associated with the offering of the service by the second device.

4. The method of claim 1, further comprising determining there to be no available connection resources corresponding to the service.

5. The method of claim 1, further comprising maintaining provision of connection to one or more additional services via the first device.

6. The method of claim 1, wherein one or more of the first device and the second device offer the service in accordance with one or more profiles.

7. The method of claim 1, wherein the priority associated with the offering of the service by the first device is lower than one or more priorities associated with offering of the service by one or more additional devices via which connection to the service is provided.

8. The method of claim 1, wherein, for each of the first device and the second device, multiple priorities are associated with offering of multiple services.

9. A method, comprising:
establishing a proximity networking device as a trusted device;
receiving specification of one or more priorities associated with offering of one or more services by the proximity networking device; and
storing one or more of the priorities.

10. The method of claim 9, further comprising receiving connection disruption specification.

11. The method of claim 9, wherein one or more of the services are offered in accordance with one or more profiles.

12. The method of claim 9, further comprising detecting the proximity networking device.

13. The method of claim 9, further comprising providing connection to one or more of the services via the proximity networking device.

14. The method of claim 9, further comprising determining there to be no available connection resources corresponding to one or more of the services.

15. The method of claim 9, wherein one or more of the priorities are exceeded by one or more priorities associated with offering of one or more services by a second proximity networking device.

16. The method of claim 9, wherein one or more of the priorities are within a predetermined range of one or more priorities associated with offering of one or more services by a second proximity networking device.

17. An apparatus, comprising:
a memory having program code stored therein; and
a processor disposed in communication with the memory for carrying out instructions in accordance with the stored program code;
wherein the program code, when executed by the processor, causes the processor to perform:
providing connection to a service via a first proximity networking device offering the service;
detecting a second proximity networking device, wherein the second proximity networking device offers the service;
comparing a priority associated with the offering of the service by the first device with a priority associated with the offering of the service by the second device;
terminating the provision of connection to the service via the first device; and
providing connection to the service via the second device.

18. The apparatus of claim 17, wherein the priority associated with the offering of the service by the second device exceeds the priority associated with the offering of the service by the first device.

19. The apparatus of claim 17, wherein the priority associated with the offering of the service by the second device is within a predetermined range of the priority associated with the offering of the service by the first device, and wherein a connection disruption indication is associated with the offering of the service by the second device.

20. The apparatus of claim 17, wherein the processor further performs determining there to be no available connection resources corresponding to the service.

21. The apparatus of claim 17, wherein the processor further performs maintaining provision of connection to one or more additional services via the first device.

22. The apparatus of claim 17, wherein one or more of the first device and the second device offer the service in accordance with one or more profiles.

23. The apparatus of claim 17, wherein the priority associated with the offering of the service by the first device is lower than one or more priorities associated with offering of the service by one or more additional devices via which connection to the service is provided.

24. The apparatus of claim 17, wherein, for each of the first device and the second device, multiple priorities are associated with offering of multiple services.

25. An apparatus, comprising:
a memory having program code stored therein; and
a processor disposed in communication with the memory for carrying out instructions in accordance with the stored program code;
wherein the program code, when executed by the processor, causes the processor to perform:
establishing a proximity networking device as a trusted device;
receiving specification of one or more priorities associated with offering of one or more services by the proximity networking device; and
storing one or more of the priorities.

26. The apparatus of claim 25, wherein the processor further performs receiving connection disruption specification.

27. The apparatus of claim 25, wherein one or more of the services are offered in accordance with one or more profiles.

28. The apparatus of claim 25, wherein the processor further performs detecting the proximity networking device.

29. The apparatus of claim 25, wherein the processor further performs providing connection to one or more of the services via the proximity networking device.

30. The apparatus of claim 25, wherein the processor further performs determining there to be no available connection resources corresponding to one or more of the services.

31. The apparatus of claim 25, wherein one or more of the priorities are exceeded by one or more priorities associated with offering of one or more services by a second proximity networking device.

32. The apparatus of claim 25, wherein one or more of the priorities are within a predetermined range of one or more priorities associated with offering of one or more services by a second proximity networking device.

33. An article of manufacture comprising a computer readable medium containing program code that when executed causes an apparatus to perform:
providing connection to a service via a first proximity networking device offering the service;
detecting a second proximity networking device, wherein the second proximity networking device offers the service;
comparing a priority associated with the offering of the service by the first device with a priority associated with the offering of the service by the second device;
terminating the provision of connection to the service via the first device; and
providing connection to the service via the second device.

34. An article of manufacture comprising a computer readable medium containing program code that when executed causes an apparatus to perform:
establishing a proximity networking device as a trusted device;
receiving specification of one or more priorities associated with offering of one or more services by the proximity networking device; and
storing one or more of the priorities.
